(19) United States
(12) Patent Application Publication
(10) Pub. No.: US 2025/0111645 A1
(43) Pub. Date: Apr. 3, 2025

(54) OCT IMAGE PROCESSING DEVICE, STORAGE MEDIUM STORING OCT IMAGE PROCESSING PROGRAM AND OCT IMAGE PROCESSING METHOD

(71) Applicant: NIDEK CO., LTD., Gamagori-shi (JP)

(72) Inventors: Ryosuke SHIBA, Gamagori-shi (JP); Tetsuya KANO, Gamagori-shi (JP)

(21) Appl. No.: 18/896,688

(22) Filed: Sep. 25, 2024

(30) Foreign Application Priority Data
Sep. 29, 2023 (JP) 2023-169858

(51) Int. Cl. G06V 10/72; G06T 7/00; G06V 10/24; G06V 10/32; G06V 10/774; G06V 10/82

(52) U.S. Cl. CPC G06V 10/72; G06T 7/0012; G06V 10/24; G06V 10/32; G06V 10/774; G06V 10/82; G06T 2207/10101; G06T 2207/20081; G06T 2207/20084; G06V 2201/03

(57) ABSTRACT

An OCT image processing device includes a control unit is programmed to perform: an image acquisition step of acquiring the OCT image taken by the OCT device; a normalization step of performing a normalization process on the OCT image acquired at the image acquisition step to generate a normalized image from the OCT image; and a medical information acquisition step of acquiring medical information output by a mathematical model by inputting the normalized image generated at the normalization step into the mathematical model that has been trained by a machine learning algorithm using a plurality of training images that are OCT images. The normalized image is generated by approximating at least one of characteristics of the OCT image to statistical information of characteristics of the plurality of training images.

### CROSS REFERENCE TO RELATED APPLICATION

This application is based on, and claims the benefit of priority from, Japanese Patent Application No. 2023-169858 filed on Sep. 29, 2023. The entire disclosure of the above application is incorporated herein by reference.

### TECHNICAL FIELD

The present disclosure relates to an OCT image processing device for processing data of an OCT image of a living tissue taken by an OCT device, an OCT image processing program executed by the OCT image processing device, and an OCT image processing method.

### BACKGROUND

A technique for obtaining various medical information by processing images of biological tissues using a mathematical model trained by a machine learning algorithm has been known. For example, a typical ophthalmic image processing device acquires a target image with high-quality than an input ophthalmic image as medical information by inputting the ophthalmic image into a mathematical model learned by a machine learning algorithm. Further, another type image processing device acquires a detection result of at least one of a specific boundary of tissue and a specific site in the ophthalmic image as medical information by inputting an ophthalmic image into a mathematical model learned by a machine learning algorithm. In addition, a technique for obtaining medical information on a tissue disease in an ophthalmic image using a mathematical model has also been known.

### SUMMARY

In a conventional technology, when using a mathematical model trained by a machine learning algorithm, high-quality medical information may not be obtained when OCT images with characteristics different from those of training images used to train the mathematical model are input into the mathematical model. For example, the quality of an image output from the mathematical model may be rather deteriorated compared with that of the image input into the mathematical model when the input OCT image has already high quality. Therefore, it has been desirable to acquire higher quality medical information by using a mathematical model learned by a machine learning algorithm.

One objective of the present disclosure is to provide an OCT image processing device and a storage medium storing an OCT image processing program capable of acquiring higher quality medical information using a mathematical model learned by a machine learning algorithm.

In a first aspect of the present disclosure, an OCT image processing device that processes data of an OCT image of a living tissue that is taken by an OCT device. The OCT image processing device includes: a control unit having at least one processor and at least one memory storing a computer program code, the computer program code, when executed by the at least one processor, causing the control unit to perform: an image acquisition step of acquiring the OCT image taken by the OCT device; a normalization step of performing a normalization process on the OCT image acquired at the image acquisition step to generate a normalized image from the OCT image; and a medical information acquisition step of acquiring medical information output by a mathematical model by inputting the normalized image generated at the normalization step into the mathematical model that has been trained by a machine learning algorithm using a plurality of training images that are OCT images. At the normalization process, the computer program code causes the control unit to generate the normalized image by approximating at least one of characteristics of the OCT image to statistical information of characteristics of the plurality of training images.

In a second aspect of the present disclosure, a non-transitory, computer readable, tangible storage medium storing an OCT image processing program executed by an OCT image processing device that processes data of an OCT image of a living tissue taken by an OCT device. The OCT image processing program, when executed by a control unit of the OCT image processing device, causes the OCT image processing device to perform: an image acquisition step of acquiring the OCT image taken by the OCT device; a normalization step of performing a normalization process on the OCT image acquired at the image acquisition step to generate a normalized image of the OCT image; and a medical information acquisition step of acquiring medical information output by a mathematical model by inputting the normalized image generate at the normalization step into the mathematical model that has been trained by a machine learning algorithm using a plurality of training images that are OCT images. At the normalization process, the OCT image processing program causes the OCT image processing device to generate the normalized image by approximating at least one of characteristics of the OCT image to statistical information of characteristics of the plurality of training images.

In a third aspect of the present disclosure, an OCT image processing method for processing data of an OCT image of a living tissue that is taken by an OCT device. The OCT image processing method includes: an image acquisition step of acquiring the OCT image taken by the OCT device; a normalization step of performing a normalization process on the OCT image acquired at the image acquisition step to generate a normalized image from the OCT image; and a medical information acquisition step of acquiring medical information output by a mathematical model by inputting the normalized image generated at the normalization step into the mathematical model that has been trained by a machine learning algorithm using a plurality of training images that are OCT images. At the normalization process, the normalized image is generated by approximating at least one of characteristics of the OCT image to statistical information of characteristics of the plurality of training images.

According to the OCT image processing device, the storage medium storing the OCT image processing program, and the OCT image processing method in the present disclosure, higher quality medical information can be acquired using a mathematical model learned by a machine learning algorithm.

### BRIEF DESCRIPTION OF DRAWINGS

FIG. 1 is a block diagram showing a schematic configuration of a mathematical model creating device 1, an OCT image processing device, and OCT devices.

FIG. 2 is a diagram showing one example of input data and output data when high-quality OCT image data is output, as medical information, from a mathematical model.

FIG. 3 is a flowchart of an OCT image process executed by the OCT image processing device.

FIG. 4 is a diagram for explaining an example of a method for adding a background area to an OCT image with a tissue-imaged area being located at the middle of an imaged range of the OCT image in a depth direction.

FIG. 5 is a diagram for explaining an example of a method for adding a background area to the OCT image with a surface position of the tissue being substantially same as that for the training images.

FIG. 6 is a diagram for explaining an example of a method for extracting a part of an area in depth direction from the OCT image.

FIG. 7 is a diagram for explaining an example of a method for restoring an arrangement of medical information to an original arrangement of the OCT image prior to a tilt of a layer being reduced.

### DESCRIPTION OF EMBODIMENTS

### Overview

An OCT image processing device according to the present disclosure processes data of OCT images of living tissues captured by the OCT device. A control unit of the OCT image processing device executes an image acquisition step, a normalization step, and a medical information acquisition step. At the image acquisition step, the control unit acquires an OCT image captured by the OCT device. At the normalization step, the control unit executes a normalization process on the OCT image acquired at the image acquisition step. At the medical information acquisition step, the control unit acquires medical information output by a mathematical model by inputting a normalized image into the mathematical model. The mathematical model has been trained by a machine learning algorithm to output medical information by OCT images being inputted into the mathematical model. The normalized image is acquired by executing the normalization process on the OCT image. At the normalization process executed at the normalization step, the control unit approximates at least one of characteristics of the OCT image to statistical information of characteristics of plural training images. The training images are OCT images (i.e., the training OCT images) used to train the mathematical model.

When using medical information output by a mathematical model by inputting an image into the mathematical model trained by a machine learning algorithm, it was found that the quality of the medical information output by the mathematical model tends to deteriorate if the characteristics of the image input into the mathematical model are different from those of training images that were used to train the mathematical model. In particular, each device that captures an image has a significantly different imaged range in a depth direction of the tissue. In addition, the characteristics of the OCT image (for example, SNR, etc.) may vary greatly depending on conditions for capturing the OCT images. Therefore, when the medical information is acquired by inputting an OCT image into the mathematical model, the quality of the medical information may be deteriorated.

On the contrary, according to the present disclosure, the normalization process is first executed by approximating the characteristics of the OCT image to the statistical information of the characteristics of the training images that were used to train the mathematical model. Then, the OCT image (i.e., the normalized image) on which the normalization process was executed is input into the mathematical model. As a result, high-quality medical information can be output by the mathematical model.

It is possible to use various mathematical models. For example, the mathematical model may perform an analysis process on at least one of a specific structure and a specific disease appearing in the OCT image, and output information indicative of analysis results as the medical information. When the OCT images is an ophthalmological image of a subject eye, analysis results of at least one of layers of the fundus tissue of the subject eye, boundaries of the layers of the fundus tissue, an optic disc present in the fundus, a fovea, boundaries of the layers of the anterior segment tissue, and a diseased area of the subject eye may be output. Further, the mathematical model may output high-quality image data as medical information in which the image quality (i.e., resolution) of the input OCT image is improved by inputting the OCT image into the mathematical model. Further, the mathematical model may perform an automatic diagnosis process on the tissue appearing in the OCT image, and output data indicative of automatic diagnosis results as the medical information. Further, the mathematical model may output reliability information indicative of reliability of processing (for example, structure or disease analysis processing, etc.) performed on the input OCT image as the medical information. “Reliability” may be degree of certainty of OCT image processing using a mathematical model or may be a reciprocal number of the low degree of certainty (may also be expressed as “uncertainty”).

In the normalization process, the control unit refers to additional information indicating the characteristics of the OCT image. The additional information is added to the data of the OCT image acquired at the image acquisition step. The control unit may approximate at least one of the characteristics of the OCT image indicated by the referenced additional information to the statistical information of the characteristics of the plurality of training images. In this case, the characteristics of the acquired OCT image are accurately acquired because of the additional information. Therefore, the control unit can appropriately approximate the characteristics of the acquired OCT image to the statistical information of the characteristics of the training images.

Various types of information can be used as the additional information. For example, the additional information in compliance with an international standard (for example, Digital Imaging and Communications in Medicine: DICOM, etc.) that defines a communication protocol and storage protocol for medical image data is attached to each OCT image. In this case, the control unit may perform a normalization process by referring to the additional information in compliance with DICOM. The additional information may indicate, for example, at least one of characteristics such as the size of the OCT image (size in the depth direction of the tissue) and the resolution.

However, the control unit may also perform the normalization process without referring to the additional information of the OCT image. For example, the control unit performs the process (for example, an analysis process for at least one of a specific structure and a disease appearing in the OCT image, etc.) on the OCT image acquired at the image acquisition step, and performs the normalization process based on the characteristics of the OCT image acquired by the process.

At the normalization process, the control unit may approximate the imaged range of the OCT image in the depth direction to a statistical imaged range (e.g., a averaged imaged range) for a plurality of training images in the depth direction by adding a background area to the OCT image in the depth direction when the imaged range, in the depth direction, of the tissue appearing in the OCT image acquired at the image acquisition step is narrower than statistical information of the imaged range (i.e., the statistical imaged range) for the plurality of training images. In this case, the image statistics (e.g., at least one of the average luminance and standard deviation, etc.) of the acquired OCT image gets close to the image statistics of the plurality of training images. Therefore, even if the imaged range of the OCT image in the depth direction is different from the imaged range in the depth direction for the plurality of training images, the mathematical model can appropriately output high quality information by inputting the normalized image into the mathematical model.

A specific method for adding the background area to the OCT image in the depth direction may be selected as appropriate. For example, regardless of the size of the imaged range in the depth direction, the OCT image may be captured so that the image of the layer is located at the center of the imaged range in the depth direction. In this case, the control unit may add the background area to each of the ends of the OCT image in the depth direction. By adding the background area to each of the ends of the OCT image in the depth direction, the position of the tissue-imaged area of the normalized image in the depth direction to which a pair of background areas are added gets close to the statistical position of the tissue-imaged area in the depth direction for the plurality of training images. As a result, the quality of the acquired medical information can be further improved. The background areas each having the same size may be added to the two ends of the OCT image in the depth direction. In this case, the position, in the depth direction, of the tissue-imaged area of the normalized image gets close to the statistical position of the tissue-imaged area for the plurality of training images with higher accuracy.

Further, regardless of the size of the imaged range in the depth direction, the OCT image may be captured with the surface position of the tissue being substantially same as the statical surface position of the training images. In this case, the control unit may add the background area only to a side (a deeper side) opposite to the surface side of the tissue among the two ends (sides) of the OCT image in the depth direction. As a result, the depth position of the tissue-imaged area in the normalized image to which the background area is added gets close to the statistical depth position of the tissue-imaged area for the plurality of training images.

When the background area is added to the OCT image in the depth direction at the normalization process, the control unit may further execute a removal step of removing information on an area corresponding to the added background area from the medical information acquired by inputting, into the mathematical model, the normalized image that is an image to which the background area is added. In this case, the acquired region of the medical information is returned to the region before the background area is added. Therefore, it is easy to obtain the medical information with high quality on the appropriate area.

However, if the medical information is not important (for example, if it is sufficient to only acquire a value such as a reliability level as the medical information), the removal step may be omitted.

At the normalization process, the control unit may approximate the imaged range of the OCT image in the depth direction to the imaged range for a plurality of training images in the depth direction by extracting a part of a tissue-imaged area in the depth direction from the OCT image when the imaged range, in the depth direction, where the tissue appears in the OCT image acquired at the image acquisition step is wider than statistical information of the imaged range for the plurality of training images. In this case, the image statistics (e.g., at least one of the average luminance and standard deviation, etc.) of the acquired OCT image gets close to the image statistics of the plurality of training images. Therefore, even if the imaged range in the depth direction for the acquired OCT image is different from the imaged range in the depth direction for the plurality of training images, the mathematical model can appropriately output high quality information by inputting the normalized image into the mathematical model.

At the normalization step, the control unit may extract at least a portion of the tissue-imaged area in which the image of the tissue appears in the OCT image when extracting a portion of the area in the depth direction from the OCT image. In this case, the tissue-imaged area appearing in the OCT image is extracted and the extracted area is input into the mathematical model as the normalized image, so that medical information on the tissue-imaged area is appropriately acquired.

A specific method for extracting a tissue-imaged area from an OCT image can be selected as appropriate. For example, it is assumed that the pixel value of the area in which a tissue image appears is larger than the pixel value of the background area in which the tissue image does not appear. The control unit may calculate a synthesized pixel value of a plurality of pixels included in a frame (for example, the total value or the average value of the plurality of pixel values, etc.) while moving, in the depth direction in the OCT image, the frame with the same size as the area to be extracted. The control unit may set the position of extracting the area to a position in the frame where the synthesized pixel value calculated in the frame has a highest value. In this case, most part of the tissue-imaged area can be extracted appropriately. As a result, higher-quality medical information can be output by the mathematical model. Similarly, when the pixel value of the area in which the tissue image appears is smaller than the pixel value of the background area in which the tissue image does not appear, the control unit may set the position of extracting the area to a position in the frame in which the synthesized pixel value (a total value or an average value, etc.) calculated in the frame has a lowest value.

Further, when extracting a portion of an area in the depth direction from the OCT image, the control unit may set the position of extracting the area in the OCT image to a position where the image of the tissue appears at the center in the depth direction. In this case, most part of the tissue-imaged area where the tissue appears in the OCT image is appropriately extracted at the normalization step. Therefore, high-quality medical information can be easily acquired. Here, it is assumed that the pixel value of the area in which the tissue image appears is larger than the pixel value of the background area in which the tissue image does not appear. The OCT image is formed of a plurality of pixel rows each extending in a direction intersecting the depth direction by arranging the plurality of pixel rows in the depth direction. For example, the control unit may calculate a synthesized value of the pixel values (for example, a total value or an average value of a plurality of pixel values, etc.) for each of the plurality of pixel rows each extending in the direction intersecting the depth direction. The control unit may align the center of the extracted area in the depth direction with a particular pixel row having a highest synthesized value of the pixel values among the plurality of pixel rows each extending in the direction intersecting the depth direction. In this case, most part of the tissue-imaged area where the tissue appears in the OCT image is appropriately extracted at the normalization step. Therefore, high-quality medical information can be easily acquired. Similarly, when the pixel value of the area in which the tissue image appears is smaller than the pixel value of the background area in which the tissue image does not appear, the control unit may align the center, in the depth direction, of the area to be extracted with a particular pixel row among the plurality of pixel rows where the calculated synthesized value of the pixel values has a lowest value.

The OCT image may be an image in which a layer of tissue appears. In such a case, at the normalization process, the control unit may extract at least a portion of the tissue-imaged area while reducing a tilt of the layer of the tissue appearing in the OCT image when extracting a portion of the tissue-imaged area in the depth direction from the OCT image. In this case, even when the layer of tissue appearing in the OCT image is curved, most part of the tissue-imaged area where the tissue appears in the OCT image is easily extracted appropriately at the normalization process. Therefore, high-quality medical information can be easily acquired. In addition, when information of a pixel located on a side of a target pixel in a direction intersecting the depth direction is used for processing by the mathematical model, the accuracy of the processing by the mathematical model can be improved by reducing the tilt of the layer.

A specific method for extracting a tissue-imaged area while reducing the tilt of the layer of tissue appearing in the OCT image may be appropriately selected. For example, it is assumed that the pixel value of the tissue-imaged area in which the tissue image appears is larger than the pixel value of the background area in which the tissue image does not appear. The OCT image is formed of a plurality of pixel rows each extending in the depth direction (for example, A-scan images extending in a direction along the optical axis of the OCT measurement light) by arranging the pixel rows in a direction intersecting the depth direction. While moving, in the depth direction, a frame having the same width as the width of the extracted area in the depth direction on each pixel row extending in the depth direction, the control unit may calculate a synthesized pixel value of a plurality of pixels included in the frame (for example, a total value or an average value of a plurality of pixel values, etc.). The control unit may set the area in the frame where the synthesized pixel value calculated in the frame has a highest value as an area to be extracted from the pixel row of interest. By performing the above process on each of the plurality of pixel rows arranged in a direction intersecting the depth direction, a tissue-imaged area may be extracted from each of the plurality of pixel rows. In this case, the plurality of tissue-imaged areas extracted from the plurality of pixel rows are arranged in a direction intersecting the depth direction, so that at least a portion of the tissue-imaged area is extracted with the tilt of the layer of tissue appearing in the OCT image being reduced. Similarly, when the pixel value of the tissue-imaged area in which the tissue image appears is smaller than the pixel value of the background area in which the tissue image does not appear, the control unit may set the area in the frame in which the synthesized pixel value calculated in the frame described above has a lowest value as a region to be extracted from the pixel row of interest.

Further, the control unit may align the positions of the tissue images in the depth direction among the plurality of pixel rows each extending in the depth direction. The control unit may extract an area in the depth direction (for example, a rectangular area, etc.) from the OCT image on which the image alignment has been performed. In addition, various methods described above (for example, a method for referring to the synthesized pixel value calculated in the frame) may be used as a method for extracting a part of the area from the OCT image in which image alignment has been performed. Further, regardless of whether at least a part of the tissue-imaged area is extracted, it is also possible to perform a process of reducing the tilt of the layer of tissue appearing in the OCT image.

When the control unit extracts at least a part of the tissue-imaged area with a reduced tilt of the layer of the tissue appearing in the OCT image during the normalization process, the control unit inputs the extracted, normalized image into the mathematical model. In this case, the arrangement of the medical information is appropriately restored according to the arrangement of the tissue actually imaged. Therefore, it is easy to obtain the medical information with high quality and appropriate arrangement.

Note that when the medical information is information such as high-quality image information, the arrangement of the medical information to be restored may be the arrangement of the tissue appearing in the image. If the medical information is analysis results of a structure (for example, the analysis results of layer boundaries, etc.), the arrangement of the medical information to be restored may be the arrangement of the analyzed structure. However, if the arrangement of the medical information is not important (for example, if it is sufficient to only acquire a value such as a reliability level as the medical information), the restoration step may be omitted. Further, the tissue-imaged area may be extracted from the OCT image without reducing the tilt of the layer. In this case, there is no need to perform the restoration step.

The control unit may approximate other characteristics of the OCT image to the statistics of the characteristics of the plurality of training images with, or in place of, the imaged range of the OCT image in the depth direction. For example, at the normalization process, the control unit may approximate statistical information of at least one of the characteristics such as the number of pixels, resolution, and a pixel value of the OCT image to the statistical information of the characteristics of the plurality of training images. Even in this case, high-quality medical information can be easily output by the mathematical model.

At the normalization process, the control unit may calculate statistical information of characteristics for at least a part of the tissue-imaged area in which the tissue image appears in the OCT image acquired at the image acquisition step. Then, the characteristics of the calculated tissue-imaged area may be approximated to the statistical information of the characteristics of the tissue-imaged area for a plurality of training images. In this case, the normalization process more suitable for the OCT image is performed as compared to a situation where the entire statistical information of the acquired OCT image is approximated to the statistical information of the training images. As a result, high-quality medical information can be easily output by the mathematical model.

Further, at the normalization process, the control unit calculates statistical information of characteristics for at least a part of a background area in which the tissue image does not appear in the OCT image acquired at the image acquisition step. Then, the characteristics of the calculated background area may be approximated to the statistical information of the characteristics of the background area for the plurality of training images. In this case, in addition to the characteristics of the tissue-imaged area, the characteristics of the background are also approximated to the statistical information of the training images. As a result, higher-quality medical information can be easily output by the mathematical model.

A specific method for calculating the statistical information of the characteristics of the tissue-imaged area may be appropriately selected. For example, the control unit may input the acquired OCT image into a mathematical model trained in advance to output a detection result of the tissue-imaged area of the OCT image (alternatively, the background area may be output) to acquire an analysis result of the tissue-imaged area in the OCT image that is output by the mathematical model. The control unit may calculate characteristic statistics for at least a portion of the acquired tissue-imaged area. Further, the control unit may perform a publicly-known image process on the OCT image to detect a tissue-imaged area (or may be a background area) in the OCT image.

### Embodiment

### Device Configuration

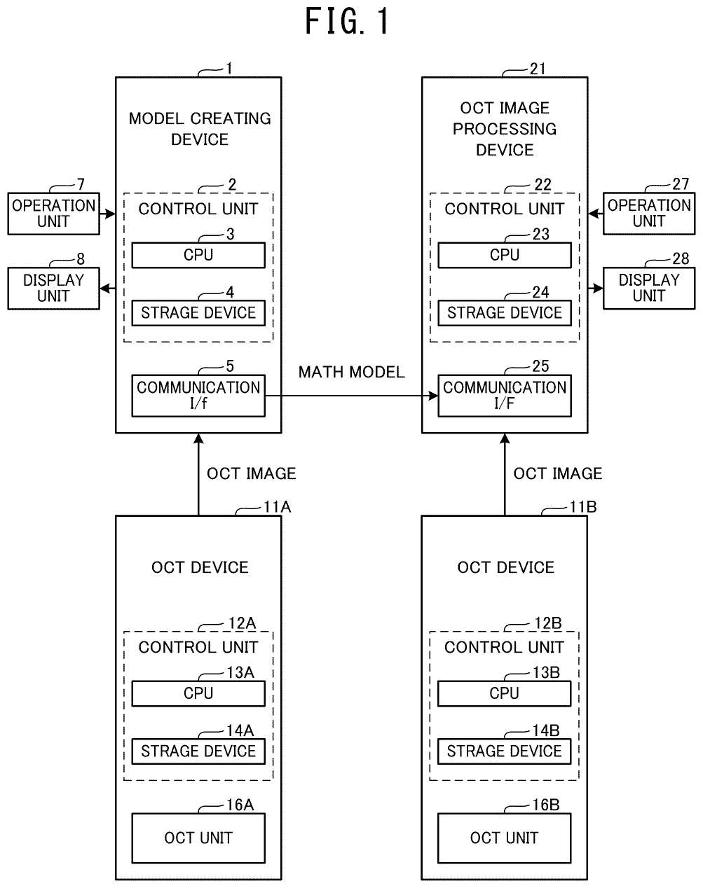

Hereinafter, one of the exemplary embodiments in the present disclosure will be described with reference to the drawings. As shown in FIG. 1, an OCT image processing system according to the present embodiment includes a mathematical model creating device 1, an OCT image processing device 21, and OCT devices 11A and 11B. The mathematical model creating device 1 creates a mathematical model which has been trained by a machine learning algorithm. A program (computer program code) that provides the created mathematical model is stored in a storage device 24 of the OCT image processing device 21. The OCT image processing device 21 acquires medical information output by the mathematical model by inputting base images (OCT images) into the mathematical model as input images. The OCT devices 11A and 11B capture the OCT images that are images of a living tissue. In the present embodiment, the OCT devices 11A and 11B capture images of the fundus tissue of a subject eye as images of a biological tissue. However, the tissue of the living body captured by the OCT device 11A and 11B may be a tissue different from the fundus tissue of the subject eye (for example, the anterior part of the subject eye, or a tissue other than the subject eye).

As an example, a personal computer (hereinafter, referred to as a “PC”) is used in the mathematical model creating device 1 of the present embodiment. As will be described in detail later, the mathematical model creating device 1 uses the OCT images (hereinafter, referred to as “training OCT images”) acquired from the OCT device 11A and the medical information (in the present embodiment, improved training OCT images) acquired from the training OCT images to create the mathematical model. However, another device other than the PC may be used as the mathematical model creating device 1. For example, the OCT device 11A may also serve as the mathematical model creating device 1. Further, control units of a plurality of devices (for example, a CPU of the PC and a CPU 13A of the OCT device 11A) may cooperate to serve as the mathematical model.

Further, in the present embodiment, a CPU is used as one example of a controller that performs various processes. However, a controller other than the CPU may be used in at least some of various devices. For example, by using a GPU as the controller, processing may be accelerated.

Next, the mathematical model creating device 1 will be described. The mathematical model creating device 1 is located, for example, in a facility of a manufacturer or a vender that provides the OCT image processing device 21 or an OCT image processing program to users. The mathematical model creating device 1 includes a control unit 2 that performs various control processes and a communication I/F 5. The control unit 2 includes a CPU 3 that is a controller and a storage device 4 that is configured to store programs, data, and the like. The storage device 4 stores a mathematical model creating program for executing a mathematical model creating process described later. Further, the communication I/F 5 connects the mathematical model creating device 1 with other devices (for example, the OCT device 11A and the OCT image processing device 21, etc.).

The mathematical model creating device 1 is connected to the operation unit 7 and the display device 8. The operation unit 7 is operated by users in order to input various instructions into the mathematical model creating device 1. For example, at least one of a keyboard, a mouse, a touch panel, or the like may be used as the operation unit 7. In addition, a microphone or the like for inputting various instructions may be used together with the operation unit 7 or in place of the operation unit 7. The display device 8 displays various images. The display device 8 may be various devices (for example, at least one of a monitor, display, projector, etc.) that are capable of displaying an image. The “image” in the present disclosure includes both a still image and a moving image (i.e., a video).

The mathematical model creating device 1 may acquire OCT image data (hereinafter, simply referred to as an “OCT image”) from the OCT device 11A. The mathematical model creating device 1 may acquire OCT image data from the OCT device 11A by, for example, at least one of wired communication, wireless communication, a removable storage medium (for example, a USB memory), or the like.

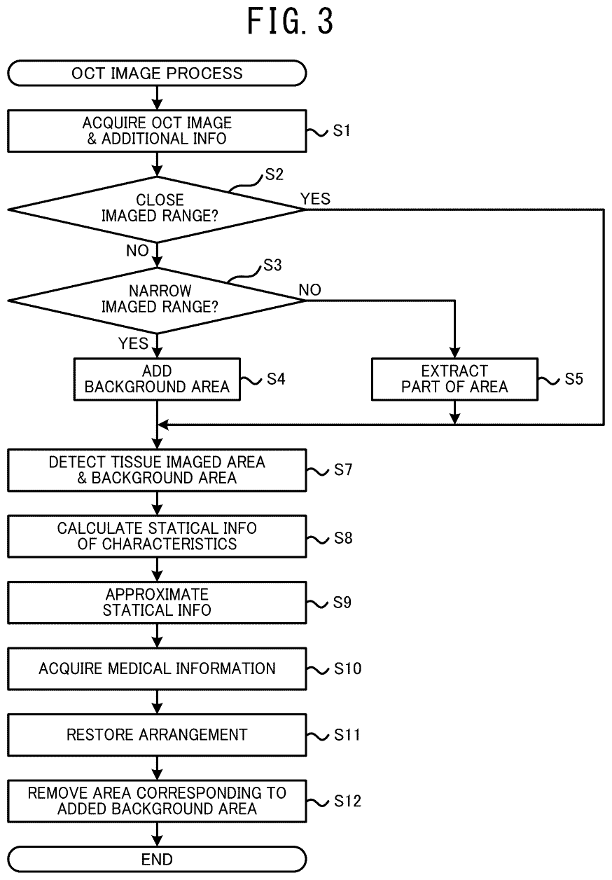

Next, the OCT image processing device 21 will be described. The OCT image processing device 21 is used at, for example, a facility (for example, a hospital or a health examination facility) that performs a diagnosis or examination for a subject. The OCT image processing device 21 includes a control unit 22 that performs various control processes and a communication I/F 25. The control unit 22 includes a CPU 23 that is at least one processor and a storage device 24 that is at least one memory and stores programs, data, and the like. The storage device 24 stores an OCT image processing program (i.e., computer program code) for executing an OCT image process (see FIG. 3) as will be described later. The OCT image processing program includes a program that provides the mathematical model created by the mathematical model creating device 1. The communication I/F 25 connects the OCT image processing device 21 to other devices (e.g., the OCT device 11B and the mathematical model creating device 1, etc.).

The OCT image processing device 21 is connected to the operation unit 27 and the display device 28. As with the operation unit 7 and the display unit 8 described above, various devices can be used as the operation unit 27 and the display unit 28.

The OCT image processing device 21 acquires OCT images from the OCT device 11B. The OCT image processing device 21 may acquire OCT images from the OCT device 11B by, for example, at least one of wired communication, wireless communication, a detachable storage medium (for example, a USB memory), and the like. Further, the OCT image processing device 21 may acquire, via network communication or the like, a program or the like for providing the mathematical model created by the mathematical model creating device 1.

Next, the OCT devices 11A and 11B will be described. As an example, in the present embodiment, the OCT device 11A that provides OCT images to the mathematical model creating device 1 and the OCT device 11B that provides OCT images to the OCT image processing device 21 are used. However, the number of OCT devices is not necessarily limited to two. For example, the mathematical model creating device 1 and the OCT image processing device 21 may acquire OCT images from a plurality of OCT devices. Further, the mathematical model creating device 1 and the OCT image processing device 21 may acquire OCT images from a single OCT device.

The OCT device 11 (11A, 11B) includes a control unit 12 (12A, 12B) that performs various control processes and an OCT unit 16 (16A, 16B). The control unit 12 includes a CPU 13 (13A, 13B) that is a controller and a storage device 14 (14A, 14B) capable of storing programs, data, and the like. When the OCT device 11 executes at least a part of the OCT image process (see FIG. 3) described later, at least a part of the OCT image processing program for performing the OCT image process is stored in the storage device 14.

The OCT unit 16 includes various configurations necessary for capturing OCT images of living tissues (e.g., fundus tissues of the subject eye in the present embodiment). The OCT unit 16 in this embodiment includes an OCT light source, a branching optical element that branches OCT light emitted from the OCT light source into a measurement light and a reference light, a scanning section for scanning a target with the measurement light, an optical system for irradiating a subject's eye with the measurement light, and a light receiving element that receives the combined light of the light reflected by the tissue and the reference light.

The OCT device 11 captures two-dimensional tomographic images and three-dimensional tomographic images of the fundus of the subject eye. In detail, the CPU 13 captures a two-dimensional tomographic image of a cross-section along a scan line by scanning the subject eye with OCT light (measurement light) on the scan line. Furthermore, the CPU 13 may also capture a three-dimensional tomographic image of the tissue by performing two-dimensional scanning with the OCT light. For example, the CPU 13 acquires a plurality of two-dimensional tomographic images by emitting measurement light on each of the plurality of scan lines that are located at different positions within a two-dimensional region when the tissue is viewed from a front side. Next, the CPU 13 acquires a three-dimensional tomographic image by combining a plurality of captured two-dimensional tomographic images.

Furthermore, the CPU 13 may also capture a plurality of OCT images at the same tissue site by emitting the measurement light multiple times at the same site on the tissue (in the present embodiment, on the same scan line). The CPU 13 may acquire an addition image in which the influence of speckle noise is reduced by performing an addition process on a plurality of OCT images at the same site. By performing the addition process on a plurality of two-dimensional tomographic images at the same site, the image quality of the two-dimensional tomographic images can be improved. The addition process may be performed, for example, by averaging pixel values of pixels at the same site among the plurality of OCT images (that is, an addition averaging process may be performed). The larger the number of images subject to the addition process, the more the effect of speckle noise can be reduced, but the longer the required time for capturing the image. Note that the OCT device 11 executes a tracking process for causing scanning positions of the OCT light to be aligned with movement of the subject eye while capturing a plurality of OCT images at the same site.

### Mathematical Model Creating Process

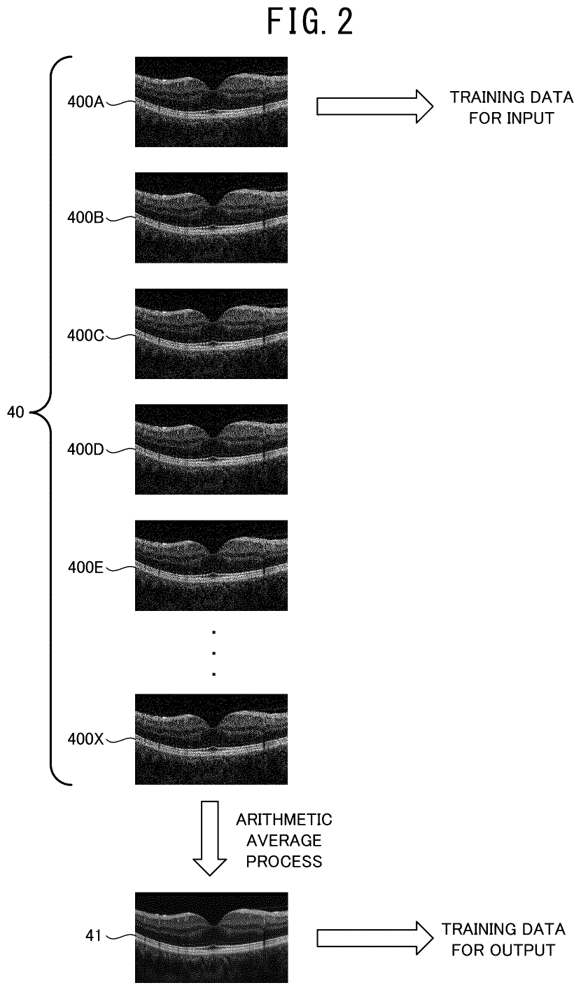

With reference to FIG. 2, a mathematical model creating process executed by the mathematical model creating device 1 will be described. The mathematical model creating process is executed by the CPU 3 according to the mathematical model creating program stored in the storage device 4.

At the mathematical model creating process, a mathematical model is trained using a plurality of training datasets, thereby creating the mathematical model to output medical information based on OCT images. The training datasets include data for input (input training data) and data for output (output training data). The mathematical model may output various medical information. Depending on the type of medical information to be output by the mathematical model, the type of the training datasets used to train the mathematical model is determined.

In this embodiment, by inputting an OCT image (for example, a two-dimensional tomographic image) into the mathematical model as a base image, the mathematical model outputs, as the medical information, an OCT image with improved quality (i.e., a high-quality image) based on the base image. In this case, in the present embodiment, training image s(two-dimensional tomographic images) that are OCT images of the tissue of the subject eye are used as the input training data, and OCT images of the same site having higher image quality than the input training data are used as the output training data. The high-quality image is one of, for example, an image in which the noise of the input base image is reduced, an image in which the resolution of the original image is increased, an image in which the visibility of the original image is improved, and the like.

FIG. 2 shows an example of a training dataset (input training data and output training data) for the mathematical model to output high-quality OCT image data as medical information. In the example shown in FIG. 2, the CPU 3 acquires a set 40 of a plurality of OCT images 400A to 400X taken at the same site in the tissue. The CPU 3 uses some of the plurality of OCT images 400A to 400X in the set 40 (the number of the OCT images is less than the number of images used to calculate an addition average of the output training data described later) as the input training data (i.e., training data images). Further, the CPU 3 acquires the addition average image 41 of the plurality of OCT images 400A to 400X in the set 40 as the output training data. When the mathematical model is trained by the input training data and the output training data illustrated in FIG. 2, the OCT image is input into the trained mathematical model as a base image, and high-quality image data with the effect of speckle noise being reduced is output as the medical information.

However, it is also possible to change the configuration of the mathematical model. For example, the mathematical model may perform an analysis process on at least one of a specific structure and a specific disease appearing in the OCT image, and output data indicative of analysis results as the medical information. In this case, at least one of a layer of a living tissue (for example, fundus tissue of the subject eye, etc.), a layer boundary of a living tissue (for example, fundus tissue, etc.), a specific structure of the tissue (for example, a blood vessel in the fundus, an optic nerve disc, or a macula, etc.), a disease site appearing in a living tissue, etc. may be output. Further, the mathematical model may perform an automatic diagnosis process on the tissue appearing in the OCT image, and output data indicative of automatic diagnosis results as the medical information. Further, the mathematical model may output reliability information indicative of reliability of processing (for example, structure or disease analysis processing, etc.) performed on the input OCT image as the medical information. The type or form of the training dataset may be appropriately selected depending on the function of the mathematical model to be created.

Next, the mathematical model creating process will be described. The CPU 3 acquires at least some of the OCT images captured by the OCT device 11A as the input training data. Next, the CPU 3 acquires output training data corresponding to the input training data. An example of the correspondence between the input training data and the output training data is described above.

Next, the CPU 3 performs training of the mathematical model using the training dataset by a machine learning algorithm. An example of the machine learning algorithm includes neural networks, random forests, boosting, support vector machines (SVMs), and the like.

The neural network is a method that imitates the behavior of biological nerve cell networks. The neural network includes, for example, feedforward neural networks, RBF networks (radial basis functions), spiking neural networks, convolutional neural networks, recurrent neural networks (recurrent neural networks, feedback neural networks, etc.), and stochastic neural networks (Boltzmann machines, Bassian networks, etc.).

Random forest is a method of generating a large number of decision trees by performing learning based on randomly sampled training data. When using a random forest, branches of multiple decision trees trained in advance as a classifier are followed, and the average (or the majority vote) of the results obtained from each decision tree is calculated.

Boosting is a method of generating a strong classifier by combining multiple weak classifiers. A strong classifier is created by sequentially training simple and weak classifiers.

SVM is a method of creating a two-class pattern discriminator using linear input elements. The SVM learns the parameters of a linear input element based on the criterion (hyperplane separation theorem) of finding a margin-maximizing hyperplane that maximizes the distance to each data point from training data.

The mathematical model refers to, for example, a data structure for predicting the relationship between the input training data and the output training data. The mathematical model is created by being trained using training datasets. As described above, the training dataset is a set of the input training data and the output training data. For example, the correlation data (e.g., weights) of each input and each output is updated by training.

In this embodiment, a multilayered neural network is used as the machine learning algorithm. A neural network includes an input layer for inputting data, an output layer for generating data to be predicted, and one or more hidden layers between the input layer and the output layer. A plurality of nodes (also called as “units”) are arranged in each layer. Specifically, in this embodiment, a convolutional neural network (CNN), which is one type of multilayer neural networks, is used. However, other machine learning algorithms may be used. For example, generative adversarial networks (GAN), which utilize two competing neural networks, may be used as the machine learning algorithm.

The above processes are repeated until the mathematical model is created. When creation of the mathematical model is completed, a program and data for providing the created mathematical model are stored in the OCT image processing device 21. Further, statistical information of the characteristics of the plurality of training images (that is, the plurality of OCT images used as the input training data) used to train the created mathematical model is stored in the storage device 24 of the OCT image processing device 21. In the present embodiment, statistical information on an imaged range for the plurality of training images in the depth direction (hereinafter, may be referred to as a “statistical imaged range” of the plurality of training imagers) is stored in the storage device 24 as the statistical information of the characteristics of the plurality of training images. Further, in the present embodiment, statistical information of at least one of the characteristics such as the number of pixels, resolution, and pixel values of the plurality of training images is also stored in the storage device 24 as the statistical information of the characteristics of the plurality of training images. However, other information may be stored in the storage device 24 as the statistical information of the characteristics of the training images. For example, only statistical information on the imaged range (i.e., the statistical imaged range) for the training images in the depth direction may be stored in the storage device 24. Further, instead of the statistical information on the imaged range in the depth direction, only statistical information of at least one of characteristics such as the number of pixels, resolution, and pixel values may be stored in the storage device 24.

### OCT Image Process

With reference to FIGS. 3 to 7, an example of the OCT image process executed by the OCT image processing device 21 will be described. At the OCT image process, the medical information is acquired by inputting an OCT image into the mathematical model trained by the machine learning algorithm. As described above, the mathematical model is pre-trained by the training datasets (the training images) so as to output the medical information by inputting an OCT image into the model. Here, in the OCT image process of the present embodiment, a normalization process is performed to approximate at least one of the characteristics of the OCT image to the statistical information of the characteristics of the plurality of training images, and a normalized OCT image (a normalized image) is input into the mathematical model. As a result, high-quality medical information can be output by the mathematical model. The OCT image process exemplified in FIG. 3 is performed by the CPU 23 according to the OCT image processing program stored in the storage device 24.

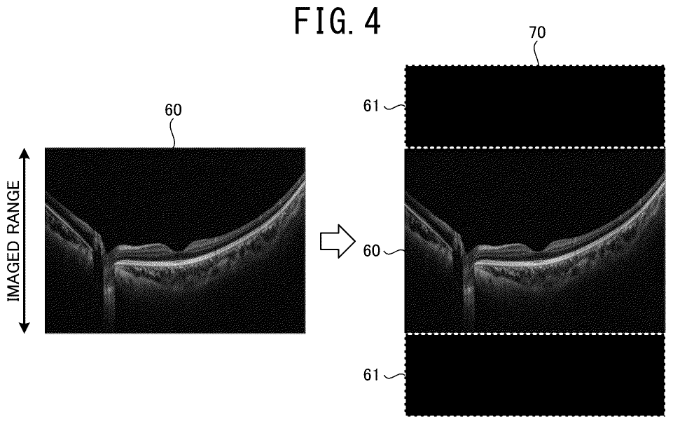

First, the CPU 23 acquires an OCT image 60 of a living tissue (in the present embodiment, a tomographic image of the fundus tissue of the subject eye) taken by the OCT device 11B (S1). FIGS. 4 to 6 show an example of a two-dimensional OCT image 60 captured by the OCT device 11B. In the present disclosure, the Z direction (the vertical direction in FIGS. 4 to 6) along the optical axis of the OCT measurement light is a depth direction of the tissue. The two-dimensional OCT image 60 captured by the OCT device is formed of a plurality of A-scan images. The A-scan image is a plurality of pixel rows each extending in a direction along the optical axis of the OCT measurement light (that is, the Z direction which is the depth direction). In other words, a plurality of A-scan images each extending in the Z direction are arranged in the X direction (in this embodiment, the direction in which the spot of the OCT measurement light is emitted onto the tissue) perpendicular to the Z direction such to form the two-dimensional OCT image 60. When a tomographic image of the fundus tissue of the subject eye is captured by the OCT device 11B according to this embodiment, most of the layers of the fundus tissue that appear in the captured tomographic image usually extend and are curved in the X direction that is perpendicular to the Z direction along the optical axis of the OCT measurement light.

Further, in the present embodiment, additional information indicative of the characteristics of the OCT images 60 is attached to the data of each OCT image (for example, each data of the three-dimensional OCT image). At S1, the additional information attached to the OCT image 60 is also acquired along with the OCT image 60. In the present embodiment, the additional information in compliance with an international standard (for example, Digital Imaging and Communications in Medicine: DICOM, etc.) that defines a communication protocol and storage protocol for medical image data is attached to each OCT image. The CPU 23 acquires the additional information in compliance with DICOM together with the OCT image 60. The CPU 23 executes the normalization process on the OCT image 60 exemplified in S2 to S9 as described later by referring to the additional information acquired at S1. The additional information indicates, for example, at least one of characteristics such as the size of the OCT image (size in the depth direction of the tissue), the number of pixels, the resolution, and the pixel values. As described above, the statistical information of the characteristics of the training images used to train the mathematical model is stored in the storage device 24 of the OCT image processing device 21.

Among the plurality of characteristics of the OCT image 60, the CPU 23 approximates a imaged range of the OCT image 60 in the depth direction to the statistical information (the statistical imaged range in this case) of the imaged range for the plurality of training images in the depth direction that are used to train the mathematical model (S2 to S5). First, the CPU 23 refers to the additional information of the OCT image 60 and determines whether the imaged range of the OCT image 60 acquired at S1 in the depth direction is close to the statistical imaged range in the depth direction of the training images (S2). The determination at S2 may be based on, for example, whether the difference between the imaged range of the OCT image 60 acquired at S1 in the depth direction and the statistical imaged range of the training images in the depth direction is less than a threshold value. If the imaged range of the OCT image 60 is close to the statistical imaged range (S2: YES), there is a high possibility that high-quality medical information will be acquired even without adjusting the imaged range of the OCT image 60, and thus the process moves to S7.

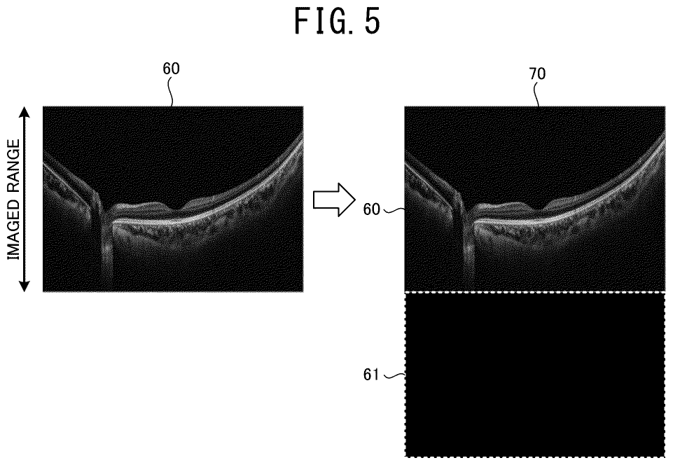

When the imaged range of the OCT image 60 acquired at S1 is narrower than the statistical imaged range of the training images (S3: YES), the CPU 23 adds a background area 61 (see FIGS. 4 and 5) to the OCT image 60 acquired at S1 in the depth direction (S4). As a result, a normalized image 70 is generated in which the imaged range of the OCT image 60 acquired at S1 is approximated to the statistical imaged range in the depth direction of the training images. As the step of S4 is executed, the image statistics (e.g., at least one of the average luminance and standard deviation, etc.) of the OCT image 60 acquired at S1 gets close to the image statistics of the plurality of training images. Therefore, even if the imaged range in the depth direction differs between the OCT image 60 acquired at S1 and the training images used for training the mathematical model, high-quality medical information can be output by the mathematical model by inputting the normalized image 70 into the mathematical model at S10, which will be described later.

An example of detailed processes executed at S4 will be described. As shown in FIG. 4, regardless of the size of the imaged range of the OCT image 60 in the depth direction, the OCT image 60 may be captured so that the image of the layer of the tissue is located at the center of the imaged range in the depth direction. In this case, the CPU 23 adds the background area 61 to each of the two ends of the OCT image 60 in the depth direction (the upper and lower ends of the OCT image 60 in FIG. 4). By adding the background areas 61 to both the ends of the OCT image 60 in the depth direction, the position of the tissue-imaged area of the normalized image 70 in the depth direction to which a pair of background areas 61 are added gets close to the statistical position of the tissue-imaged area in the depth direction for the plurality of training images. As a result, the quality of the medical information acquired at S10, which will be described later, is further improved. The background areas 61 each having the same size may be added to the two ends of the OCT image 60 in the depth direction. In this case, the position in the depth direction of the tissue-imaged area of the normalized image 70 can be approximated to the statistical position of the tissue-imaged area for the plurality of training images with higher accuracy.

Further, as shown in FIG. 5, regardless of the size of the imaged range in the depth direction, the OCT image 60 may be captured with the surface position of the tissue being substantially same as the surface position of training images. In this case, the CPU 23 adds the background area 61 only to the deeper side (a lower end in FIG. 5) that is opposite to the surface side of the tissue among the two ends of the OCT image 60 in the depth direction. As a result, the depth position of the tissue-imaged area in the normalized image 70 to which the background area 61 is added gets close to the statistical depth position of the tissue-imaged area for the plurality of training images.

Return to the description in FIG. 3. When the imaged range in the depth direction of the OCT image 60 acquired at S1 is larger than the statistical imaged range of the training images in the depth direction (S3: NO), the CPU 23 extracts an area in the depth direction from the OCT image 60 acquired at S1 (S5). As a result, a normalized image 70 is generated in which the imaged range in the depth direction of the OCT image 60 acquired at S1 is approximated to the statistical imaged range of the training images in the depth direction. As the step of S5 is executed, the image statistics (e.g., at least one of the average luminance and standard deviation, etc.) of the OCT image 60 acquired at S1 gets close to the image statistics of the plurality of training images. Therefore, as in the case where the step of S4 is executed, the normalized image 70 is input into the mathematical model at S10, which will be described later, so that high-quality medical information is appropriately output by the mathematical model.

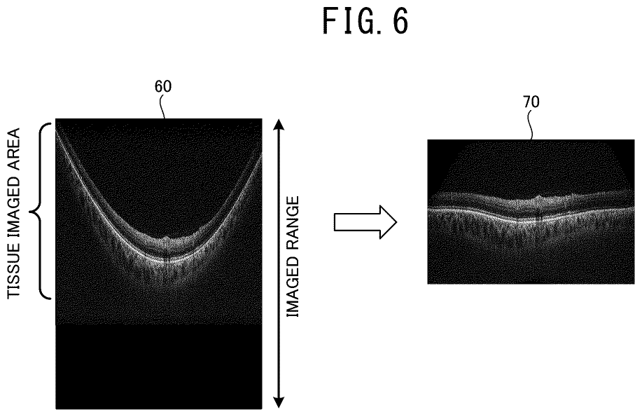

Next, an example of a detailed process executed at S5 will be described. As shown in FIG. 6, at S5, the CPU 23 extracts at least a portion of a tissue-imaged area in which the image of the tissue appears in the OCT image 60 when extracting a portion of an area in the depth direction from the OCT image 60. As a result, the normalized image 70 generated by extracting the tissue-imaged area where the tissue appears in the OCT image 60 from the COT image 60 is input into the mathematical model at S10, which will be described later. Therefore, the medical information related to the tissue-imaged area is appropriately acquired.

As shown in FIG. 6, at S5, the CPU 23 extracts at least a portion of the tissue-imaged area while reducing a tilt of the layer of tissue appearing in the OCT image 60 when extracting a portion of the imaged range in the depth direction from the OCT image 60. Therefore, even when the layer of tissue appearing in the OCT image 60 is curved, most part of the tissue-imaged area where the tissue appears in the OCT image 60 can be extracted appropriately at S5. Therefore, at S10, which will be described later, high-quality medical information can be easily acquired. In addition, when information on a pixel located on a side of a pixel of interest in a direction intersecting the depth direction (for example, X direction) is used for processing by the mathematical model, the accuracy of the processing by the mathematical model can be improved by reducing the tilt of the layer.

A method for extracting a tissue-imaged area with the tilt of the layer being reduced can be selected. For example, it is assumed that the pixel value of the tissue-imaged area in which the image of a tissue appears is larger than the pixel value of the background area in which the image of the tissue does not appear. The OCT image 60 is formed of a plurality of pixel rows each extending in the depth direction (for example, A-scan images extending in a direction along the optical axis of the OCT measurement light) by arranging the pixel rows in a direction that intersects the depth direction (for example, in the X direction). While moving, in the depth direction, a frame having the same width as the width of the extracted region in the depth direction on each pixel row extending in the depth direction, the CPU 23 calculates a synthesized pixel value of a plurality of pixels included in the frame (for example, a total value or an average value of the pixel values in the frame, etc.). The CPU 23 sets the region in the frame where the synthesized pixel value calculated in the frame has a highest value as a region to be extracted from the pixel row of interest. By performing the above process on each of the plurality of pixel rows arranged in a direction intersecting the depth direction, a tissue-imaged area is extracted from each of the plurality of pixel rows. In this case, the plurality of tissue-imaged areas each extracted from a respective pixel row are arranged in a direction that intersects the depth direction so that at least a portion of the tissue-imaged area is extracted with the tilt of the layer of the tissue appearing in the OCT image 60 being reduced. The position at which the tissue-imaged area is extracted from each of the plurality of pixel rows is stored in the storage device 24 for reference during a restoration process (S11), which will be described later.

Further, the CPU 23 may perform an image alignment (also expressed as a tilt reduction process) in the depth direction between a plurality of pixel rows (for example, a plurality of A-scan images) extending in the depth direction. The CPU 23 may extract a region in the depth direction (for example, a rectangular region, etc.) from the OCT image 60 on which the image alignment has been performed. For example, the CPU 23 may align, in the Z direction, the position of an image included in each of a plurality of small regions by moving each of the plurality of small regions (for example, a plurality of A-scan images, etc.) extending in the Z direction (i.e., the depth direction) of the OCT image 60. As a result, the tilt of the layer is appropriately reduced. Specifically, the CPU 23 may move each of the plurality of small regions in the Z-direction such that the positions of portions of the small regions each having a maximum brightness are aligned with each other in the Z direction. Alternatively, the CPU 23 may detect the amount of positional deviation between adjacent small regions using a phase-only correlation method or template matching, and then arrange the plurality of small regions so that the detected amount of deviation is eliminated. Note that the movement direction and the amount of movement of each small region are stored in the storage device 24 for reference in the restoration process (S11), which will be described later.

Note that the timing for executing the tilt reduction process is not necessarily limited to the timing of S5. For example, the CPU 23 may perform the tilt reduction process in any case where the imaged range in the depth direction of the OCT image 60 acquired at S1 is larger than, narrower than, or close to the statistical imaged range of the training images in the depth direction. In this case, for example, the tilt reduction process may be performed before the determination at S2 as described above or before performing the step of S7, which will be described later.

Next, the CPU 23 executes a process for approximating another characteristic to the statistical information of the characteristics for the plurality of training images (S7 to 9). The other characteristic is a characteristic among the characteristics of the OCT image 60 that is different from the imaged range in the depth direction. At S7 to S9 of the present embodiment, at least one of the characteristics of the number of pixels, resolution, and pixel values is approximated to the statistical information of the characteristics for the training images.

First, the CPU 23 detects the tissue-imaged area in which the image of the tissue appears in the OCT image 60 acquired at S1 (S7). For example, the CPU 23 inputs the OCT image 60 acquired at S1 into a mathematical model trained in advance to output a detection result (or an analysis result) of the tissue-imaged area in the OCT image. Further, the CPU 23 may detect the tissue-imaged area in the OCT image 60 by executing a publicly-known image process on the OCT image 60. In the present embodiment, all regions other than the tissue-imaged area in the OCT image 60 are treated as background areas. Therefore, in the step of S7, the background areas are detected as well as the tissue-imaged area.

The CPU 23 calculates the statistical information of characteristics for at least a part of the tissue-imaged area (the entire image in the present embodiment) of the OCT image 60 acquired at S1 (S8). At S3 of the present embodiment, statistical information of the characteristics of at least a part (the entire image in the present embodiment) of the background area in which the tissue image does not appear in the OCT image 60 is also calculated.

The CPU 23 approximates the statistical information of the characteristics of the tissue-imaged area in the OCT image 60 acquired at S1 to the statistical information of the characteristics of the tissue-imaged area for the plurality of training images used to train the mathematical model (S9). As a result, a normalization process more suitable for the OCT image 60 is performed as compared to a situation where the entire statistical information of the OCT image 60 acquired at S1 is calculated altogether and approximated to the statistical information of the training image. Therefore, at the step of S10, which will be described later, high-quality medical information can be output appropriately by the mathematical model.

At S9 of the present embodiment, the statistical information of the characteristics of the background area in the OCT image 60 acquired at S1 is also approximated to the statistical information of the characteristics of the background area for the plurality of training images used to train the mathematical model. As a result, in addition to the characteristics of the tissue-imaged area, the characteristics of the background area are also approximated to the statistical information for the training images. As a result, higher-quality medical information can be output by the mathematical model. However, at S9, only statistical information of the characteristics of the tissue-imaged area may be processed.

The CPU 23 inputs the normalized image (S2 to S9) generated by executing the normalization process on the OCT image 60 acquired at S1 into the mathematical model. As described above, the mathematical model is pre-trained according to a machine learning algorithm to output medical information when an OCT image (a normalized image in the present embodiment) is input into the mathematical model. The CPU 23 acquires the medical information output by the mathematical model (S10). As a result, it is easier to acquire high-quality medical information as compared to a situation where the OCT image 60 itself acquired at S1 is input into the mathematical model.

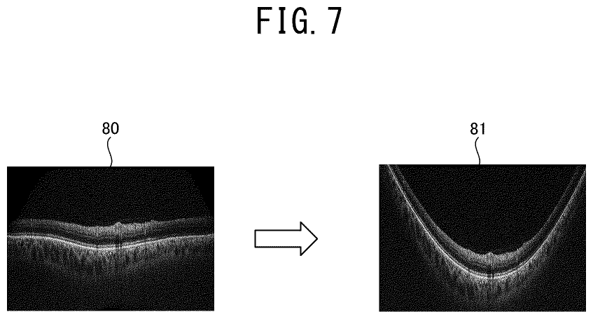

Further, at the step of S5 as described above, at least a part of the tissue-imaged area may be extracted with the tilt of the layer of tissue present in the OCT image 60 being reduced. In this case, as shown in FIG. 7, the CPU 23 executes the restoration process (S11) of restoring an arrangement of the medical information acquired by inputting the normalized image 70 generated at S5 into the mathematical model to an original arrangement of the OCT image prior to the tilt of the layer being reduced (S11). Thus, the arrangement of the medical information is appropriately restored according to the arrangement of the tissue actually imaged. Therefore, it is easy to obtain the medical information with high quality and appropriate arrangement. The medical information acquired at S10 in the present embodiment is a high-quality image 80 (see FIG. 7) obtained by improving the image quality of the OCT image 60 acquired at S1. In this case, the arrangement of the medical information restored by S11 is the arrangement of tissue appearing in the high-quality image. In the example shown in FIG. 7, a restored image 81 is generated by restoring the tissue arrangement of the high-quality image 80 acquired at S10. However, when the medical information acquired at S11 is the analysis result of a structure or disease (for example, an analysis result such as a layer boundary, etc.), the arrangement of the medical information restored at S11 may be the arrangement of the analyzed structure or disease. As described above, the step of S11 may be performed by referring to the information that was stored when extracting a part of the region at S5.

Further, at the step of S4 described above, the background area 61 (see FIGS. 4 and 5) may be added to the OCT image 60 in the depth direction. In this case, the CPU 23 executes a removal process (S12) that removes information on an area corresponding to the background area 61 added at S4 from the medical information acquired by inputting, into the mathematical model, the normalized image 70 to which the background area is added at S4 (S12). As a result, the acquired region of the medical information is returned to the region before the background area 61 is added. Therefore, it is easy to obtain the medical information with high quality on the appropriate area.

The technique disclosed in the above embodiment is just one example. Thus, it is also possible to change the technique illustrated in the above embodiment. First, only a part of the processes exemplified in the above-described embodiment may be executed. For example, in the OCT image processing shown in FIG. 3, it is possible to omit one of the normalization process (S2 to S5) of the imaged range in the depth direction and the normalization process (S7 to S9) having characteristics different from the imaged range in the depth direction. Further, in the normalization process (S7 to S9) of characteristics different from the imaged range in the depth direction, it is also possible to process statistical information of characteristics of the entire OCT image 60 without processing the statistical information of characteristics of the tissue-imaged area in the OCT image 60.

Further, at S5 of the above embodiment, at least a part of the tissue-imaged area is extracted while reducing the tilt of the layer of the tissue appearing in the OCT image 60. However, at S5, the tissue-imaged area in the OCT image 60 may be extracted without reducing the tilt of the layer. In this case, a method for extracting the tissue-imaged area can be appropriately selected. For example, it is assumed that the pixel value of the area in which the tissue appears is larger than the pixel value of the background area in which the tissue does not appear. The CPU 23 may calculate the synthesized pixel value of a plurality of pixels included in the frame (for example, the total value or the average value of a plurality of pixel values, etc.) while moving, in the depth direction in the OCT image 60, the frame with the same size as the area to be extracted. The CPU 23 may set the extraction position for the area to a position in the frame where the synthesized pixel value calculated in the frame has a highest value. In this case, most part of the tissue-imaged area can be extracted appropriately. Further, when extracting a portion of the area in the depth direction from the OCT image 60, the CPU 23 may set the position of extracting the area in the OCT image 60 to a position where the image of the tissue is located at the center in the depth direction. In this case, most part of the tissue-imaged area where the tissue appears in the OCT image 60 is appropriately extracted at S5. Specifically, the OCT image 60 is formed by arranging, in the depth direction, a plurality of pixel rows each extending in a direction intersecting the depth direction (for example, in the X direction). For example, the CPU 23 may calculate a synthesized value of the pixel values (for example, a total value or an average value of the plurality of pixel values, etc.) for each of the plurality of pixel rows each extending in the direction intersecting the depth direction. The CPU 23 may align the center of an area to be extracted in the depth direction with a particular pixel row having a highest synthesized value of the pixel values among the plurality of pixel rows each extending in a direction intersecting the depth direction. In this case, most part of the tissue-imaged area where the tissue appears in the OCT image 60 is appropriately extracted at the step of S5.

The process of acquiring an OCT image at S1 in FIG. 3 is an example of an “image acquisition step”. The normalization process performed on the OCT image at S2 to S9 is an example of a “normalization step”. The process of acquiring medical information at S10 is an example of a “medical information acquisition step”. The restoration process executed at S11 is an example of a “restoration step”. The removal process executed at S12 is an example of a “removal step”.

1. An OCT image processing device that processes data of an OCT image of a living tissue that is taken by an OCT device, the OCT image processing device comprising:
a control unit having at least one processor and at least one memory storing a computer program code, the computer program code, when executed by the at least one processor, causing the control unit to perform:
an image acquisition step of acquiring the OCT image taken by the OCT device;
a normalization step of performing a normalization process on the OCT image acquired at the image acquisition step to generate a normalized image from the OCT image; and
a medical information acquisition step of acquiring medical information output by a mathematical model by inputting the normalized image generated at the normalization step into the mathematical model that has been trained by a machine learning algorithm using a plurality of training images that are OCT images, wherein
at the normalization process, the computer program code causes the control unit to generate the normalized image by approximating at least one of characteristics of the OCT image to statistical information of characteristics of the plurality of training images.

2. The OCT image processing device according to claim 1, wherein
additional information indicating the characteristics of the OCT image is attached to the OCT image acquired at the image acquisition step,
at the normalization process, the computer program code causes the control unit to:
refer to the additional information; and
generate the normalized image by approximating at least one of the characteristics of the OCT image indicated by the additional information to the statistical information of the characteristics of the plurality of training images.

3. The OCT image processing device according to claim 1, wherein
at the normalization process, the computer program code further causes the control unit to generate the normalized image by adding a background area to the OCT image acquired at the image acquisition step in a depth direction of the living tissue when an imaged range of the OCT image in the depth direction is narrower than a statistical imaged range of the plurality of training images in the depth direction.

4. The OCT image processing device according to claim 3, wherein
the computer program code further causes the control unit to:
when the normalized image was generated by adding the background area to the OCT image in the depth direction at the normalization process and the medical information was output by the mathematical model by inputting the normalized image into the mathematical model, perform a removal step of removing information on an area corresponding to the added background area from the medical information.

5. The OCT image processing device according to claim 1, wherein
the computer program code further causes the control unit to generate the normalized image by extracting a part of an area in a depth direction of the living tissue from the OCT image acquired at the image acquisition step when an imaged range of the OCT image in the depth direction is larger than a statistical imaged range of the plurality of training images in the depth direction.

6. The OCT image processing device according to claim 5, wherein
the computer program code further causes the control unit to, at the normalization process, extract at least a part of a tissue-imaged area of the OCT image where the living tissue appears in the OCT image when extracting the part of the area in the depth direction from the OCT image.

7. The OCT image processing device according to claim 6, wherein
a layer of the living tissue appears in the OCT image, and
the computer program code further causes the control unit to, when extracting the part of the area in the depth direction from the OCT image at the normalization process:
reduce a tilt of the layer of the living tissue appearing in the OCT image; and
extract at least the part of the tissue-imaged area with the tilt of the layer of the living tissue being reduced.

8. The OCT image processing device according to claim 7, wherein
the computer program code further causes the control unit to:
when the normalized image was generated by extracting the at least the part of the tissue-imaged area with the tilt of the layer of the living tissue being reduced and the medical information was output by the mathematical model by inputting the normalized image into the mathematical model, perform a restoration step of restoring an arrangement of the medical information to an original arrangement of the OCT image prior to the tilt of the layer of the living tissue being reduced.

9. The OCT image processing device according to claim 1, wherein
the computer program code further causes the control unit to, at the normalization process:
calculate statistical information of characteristics of at least a part of a tissue-imaged area where the living tissue appears in the OCT image acquired at the image acquisition step; and
generate the normalized image by approximating the calculated statistical information of the characteristics of the tissue-imaged area to statistical information of characteristics of a tissue-imaged area for the plurality of training images.

10. A non-transitory, computer readable, tangible storage medium storing an OCT image processing program executed by an OCT image processing device that processes data of an OCT image of a living tissue taken by an OCT device, the OCT image processing program, when executed by a control unit of the OCT image processing device, causing the OCT image processing device to perform:
an image acquisition step of acquiring the OCT image taken by the OCT device;
a normalization step of performing a normalization process on the OCT image acquired at the image acquisition step to generate a normalized image of the OCT image; and
a medical information acquisition step of acquiring medical information output by a mathematical model by inputting the normalized image generate at the normalization step into the mathematical model that has been trained by a machine learning algorithm using a plurality of training images that are OCT images, wherein
at the normalization process, the OCT image processing program causes the OCT image processing device to generate the normalized image by approximating at least one of characteristics of the OCT image to statistical information of characteristics of the plurality of training images.

11. An OCT image processing method for processing data of an OCT image of a living tissue that is taken by an OCT device, the OCT image processing method comprising:
an image acquisition step of acquiring the OCT image taken by the OCT device;
a normalization step of performing a normalization process on the OCT image acquired at the image acquisition step to generate a normalized image from the OCT image; and
a medical information acquisition step of acquiring medical information output by a mathematical model by inputting the normalized image generated at the normalization step into the mathematical model that has been trained by a machine learning algorithm using a plurality of training images that are OCT images, wherein
at the normalization process, the normalized image is generated by approximating at least one of characteristics of the OCT image to statistical information of characteristics of the plurality of training images.
